(19) United States
(12) Patent Application Publication
(10) Pub. No.: US 2022/0371362 A1
(43) Pub. Date: Nov. 24, 2022

(54) SELECTIVE FLEX ZONE CLIMBING WHEEL

(71) Applicants: Mantaro Networks, Inc., Germantown, MD (US); Collaborative Intelligence Pvt. Ltd., Gurugram (IN)

(72) Inventors: Nathaniel Louis ROGERS, Germantown, MD (US); Jeremy Edward PARSONS, Morriston, FL (US)

(73) Assignees: Mantaro Networks, Inc., Germantown, MD (US); Collaborative Intelligence Pvt. Ltd., Gurugram (IN)

(21) Appl. No.: 17/327,106

(22) Filed: May 21, 2021

(51) Int. Cl. B60B 15/04; B60B 7/00

(52) U.S. Cl. CPC B60B 15/04; B60B 7/0066; B60B 2900/551

(57) ABSTRACT

One or more wheel apparatuses are provided. The wheel apparatus comprises one or more rigid climbing members that extend to the outer perimeter of the wheel apparatus and are configured to maintain shape and/or relative position over all surfaces the wheel apparatus encounters. The wheel apparatus comprises one or more selective flex zones located adjacent to rigid climbing members, constructed to be passively compressed when the wheel apparatus encounters an obstacle in the path of the wheel apparatus. The wheel apparatus comprises one or more support zones located adjacent to selective flex zones that provide support for smooth rotary motion when not traversing obstacles.

### FIELD OF THE INVENTION

The subject matter herein relates to novel drive designs for mobility applications. More specifically, it relates to a passive-articulated wheel system for driving over various terrain surfaces, including stairs.

### BACKGROUND

Existing drive mechanisms utilize various heavy and complex assemblies to traverse rough terrain and climb stairs. Round wheels that are used to traverse rough terrain are large in diameter such that the height of terrain does not exceed the radius of the wheel, wherein rough terrain is defined as containing obstacles with vertical elements larger than two thirds radius of the wheel. Smooth surfaces are defined as not having obstacles greater than one twentieth the radius of the wheel. Conventional mechanisms that use tracks are typically inefficient due to the use of large, heavy, and long rotating treads to gain traction on rough surfaces. These inefficiencies in tracked driving result in slow platform speed or large power use to achieve higher speeds. Other solutions have attempted various add-ons and/or mechanisms to improve wheel performance over rough terrain but have failed to meet the mobility requirements of parts durability, reduced vibration driving over smooth surfaces, and/or shock absorption from impacts.

For mobility platforms, the ability to climb stairs, traverse rough terrain, drive at low and high speeds without excessive vibration, and survive impacts in rough terrain as well as drops in excess of several feet may be useful. Some mobility applications including robotics are hampered by weight in many ways, so light weight solutions may be useful for increased battery life, better power efficiency, drop survivability, shipping costs and portability. The use of complex pivoting mechanisms to climb stairs can be heavy and leave parts at risk of breaking during drops. Heavy and long tracked mechanisms reduce the portability and increase weight, as well as offering minimal area for shock load distribution in impact scenarios. Stairs offer a difficult challenge for mobility applications including small robotic devices. The steep and high walls are difficult to grab onto and climb without complex actively articulated joints. The platform may be lifted vertically while also providing its own forward motion, Overall, there is no current wheel design for mobility platforms and the like that is lightweight, portable, and impact resistant that is able to climb stairs.

### SUMMARY

The present disclosure includes embodiments of wheel apparatus that provides a solution of one or more, or all, the above stated problems, for example by providing a Selective Flex Zone (SFZ) wheel which meets the complex design requirements with minimal parts implementation and robust construction using a durable single construction elastomer.

An embodiment of the present disclosure is a wheel apparatus. The wheel apparatus may include one or more rigid climbing members that extend to an outer perimeter of the wheel apparatus. The one or more rigid climbing members are configured to maintain shape and relative position over all surfaces the wheel apparatus encounters. The wheel apparatus includes one or more selective flex zones located adjacent to rigid climbing members, constructed to be passively compressed when the wheel apparatus encounters an obstacle in the path of the wheel apparatus; and one or more support zones located adjacent to the one or more selective flex zones that provide support for smooth rotary motion when not traversing obstacles.

In one or more embodiments, the one or more selective flex zones support the weight of a mobility platform on flat surfaces enabling low vibration driving over surfaces without obstacles, and wherein the one or more selective flex zones deform when subjected to climbing load or an obstacle to expose at least one of the one or more rigid climbing members of the wheel apparatus that provides traction when traversing the climbing load or the obstacle. At least a portion of the selective flex zone, which is subjected to the climbing load or the obstacle, is configured to be deflected inwards from the outer periphery of the wheel apparatus.

In one or more embodiments, one or more, or each, climbing member is adjacent to two selective flex zones allowing the climbing member to be exposed when an obstacle is encountered in either direction of rotation.

In one or more embodiments, the climbing member is mechanically isolated to each of the two adjacent selective flex zones at the outer periphery of the wheel apparatus.

In one or more embodiments, a center of the wheel apparatus may comprise a compression zone configured to absorb and dissipate forces incurred from dropping or throwing a mobility platform to which the wheel apparatus is attached.

In one or more embodiments, the side of the wheel apparatus further comprises one or more side impact reduction zone constructed of one or more convex surfaces that facilitate self righting of a mobility platform to which the wheel apparatus is attached.

In one or more embodiments, the wheel apparatus is formed from a single elastomer material, the outer perimeter of the wheel apparatus further comprises locations for at least one of replaceable tread inserts and replaceable traction pads on the climbing face of the one or more rigid climbing members.

In one or more embodiments, one or more wheel apparatuses described herein may be provided, wherein one or more, or each, of the one or more wheel apparatuses may be attached to a mobility platform.

### BRIEF DESCRIPTION OF DRAWINGS

FIG. 1 illustrates an isometric view of an SFZ wheel depicting he various zones for flexibility and rigidity, in accordance with the subject matter described herein.

FIG. 2 illustrates a side section view of the SFZ wheel depicting the various zones for flexibility and rigidity, in accordance with the subject matter described herein.

FIG. 3 illustrates a side view of the SFZ wheel depicting the various zones for flexibility and rigidity, in accordance with the subject matter described herein.

FIGS. 4A and 4B illustrate detailed views of a climbing member zone and selective flex zone, respectively, of the SFZ wheel, in accordance with the subject matter described herein.

FIG. 5A illustrates an unflexed position of the SFZ wheel at smooth surface driving loads, in accordance with the subject matter described herein.

FIG. 5B illustrates compression of an SFZ of the SFZ wheel and exposure of the climbing member face, in accordance with the subject matter described herein.

FIG. 6A illustrates the front wheel stair lift of a wheeled mobility platform, in accordance with subject matter described herein.

FIG. 6B illustrates the rear wheel stair lift of a wheeled mobility platform, in accordance with subject matter described herein.

### DETAILED DESCRIPTION

Embodiments of the present disclosure include a selective flex zone (SFZ) wheel apparatus. The wheel apparatus includes a rigid climbing member, a support zone, a selective flexibility zone, and an impact compression zone. SFZ wheels as described herein are configured to maintain their circular shape and operate in a rolling motion over smooth surfaces and to change their shape to operate in a climbing motion over rough surfaces. The SFZ wheel may also maintain its circular shape for optimum rolling motion when it encounters a rough surface. The rough surface induced climbing loads cause internal movement of components within the wheel to change from its smooth surface circular shape to the climbing shape. The actuated change from smooth surface shape to climbing shape due to the induced rough terrain climbing loads defines the passive articulation of the SFZ wheel.

The SFZ wheel uses a core wheel design with a novel arrangement of one or more rigid climbing members in combination with flexibility zones and support zones in order for the wheel to grip stairs for climbing and for traversing rough terrain. When traveling over a smooth surface, the SFZs also allows the wheel to roll in a rotation that minimizes drive vibration as the SFZ maintains its shape. Additionally, all components of the wheel may be manufactured as a single component from flexible elastomer to allow the wheel to compliantly respond to impacts that are often encountered when deploying mobility platforms, such as tossing or dropping them from moving vehicles. The SFZ wheels, when mounted on a mobility platform, can climb standardized stairs using simple rotary drive motion. The SFZ wheels, when embodied on a three or more wheeled mobility platform that has the front and rear spaced appropriately for the vertical face and top surface of the stair allow efficient stair climbing. The SFZs are designed to be passively activated by the presence of a targeted load revealing the rigid climbing member zone, thereby allowing for additional grip and function.

The climbing member zones include a climbing member arm in one or more positions symmetrically located around the wheel axis of rotation. The climbing member zone section of the wheel has a symmetrical hammer-shaped climbing member head where there is a high traction pad on the climbing member face 403. When climbing stairs, the climbing member face of the climbing member is configured to approximately match the contact angle of the stair top surface for increased traction. The support zone is placed between the rigid climbing members. The support zone, however, does not support the area directly in front of the climbing member zones, thus allowing for each individual selective flex zone to compress inwardly in that space.

The outer edge of the support zone lies along the outer perimeter of the wheel. The selective flex zone may include cantilever member reaching from and attached to the support zone. An outermost end of the cantilever member aligns with the outer perimeter of the wheel. The outermost end of the cantilever member is truncated just before the climbing member. The cantilever member is supported using columns configured to remain supportive under driving forces encountered on smooth surfaces and buckle or flex when subjected to the additional forces induced when climbing stairs or other steep and rough surfaces. An advantageous feature of a single body construction is that it allows for significantly reduced parts and optimal lightweight construction.

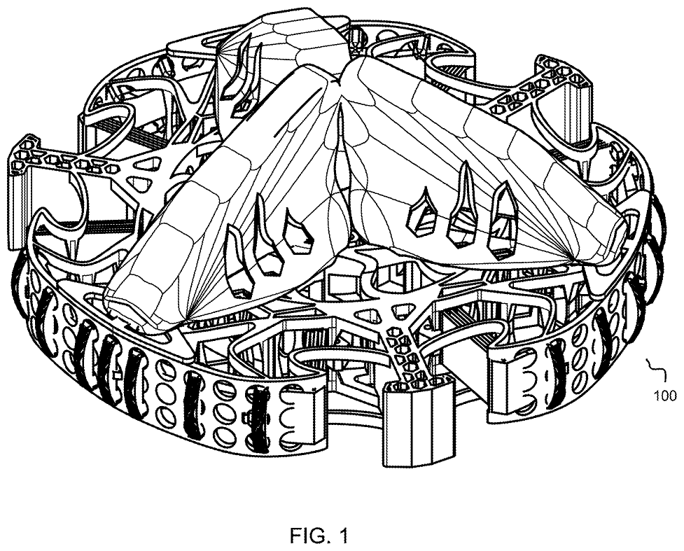

FIG. 1 illustrates an isometric view of an embodiment of the SFZ wheel. The SFZ wheel 100 allows a simple rotary drive application, the ability to climb stairs and obstacles as well as drive smoothly without actively controlling the shape of the wheel.

The SFZ wheel is constructed using an elastomer. In one example, an entirety of the wheel is formed with an elastomer. While an elastomer is used to form the material, materials with similar properties may be used as well. An elastomer material is defined as having a high failure strain along with a low Young's modulus compared to other materials, such as plastics and polymers which are more brittle. High failure strain is defined as having a percent elongation greater than one hundred percent at yield and low Young's modulus is defined as less than one Giga pascal. In one or more embodiments, the SFZ wheel could be designed by someone skilled in the art to deflect only within the elastic zone of a materials properties as defined in the stress strain curve. The SFZ wheel constructed from elastomer material may be stretched and/or flexed greater than 100 percent elongation and return to its initial form due to the elastic characteristic of the material, high strain failure and low Young's modulus. Properties of elastomers increase durability by repeatedly returning to the original shape without being deformed permanently. In one or more embodiments, perhaps for example using an elastomer based SFZ wheel, the deflection of the members in the zones are defined as minimal when the elongation is less than five percent of full elastic strain and considered large when at five percent or greater of full elastic strain.

One or more SFZ wheels 100 are configured to be coupled to a mobility platform (not shown), thereby enabling the mobility platform to move on smooth surfaces and rough terrain as well as to climb stairs or obstacles. The mobility platform, for example, may include, but is not limited to, a robot, a car, an all-terrain vehicle, or a wheelchair. The mobility platform may comprise a mechanical and/or electrical mechanism for moving the SFZ wheel 100, when the SFZ wheel 100 is coupled to the mobility platform. The SFZ wheel 100 allows for the mobility platform to drive over smooth surfaces with an axle height displacement less than ten percent of the diameter of the wheel, as referenced to the surface being traveled over. The flexible elastomer and design absorbs omnidirectional impacts to the mobility platform.

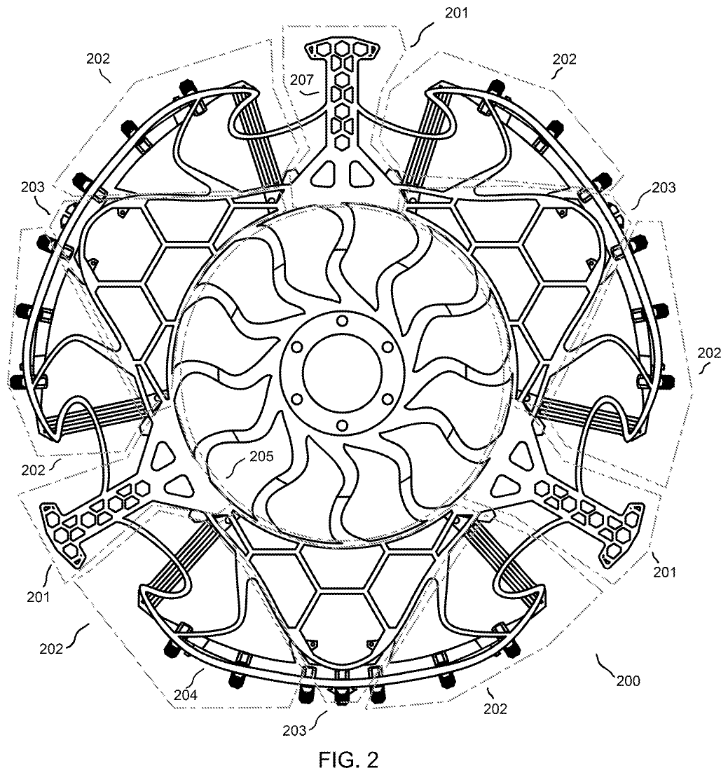

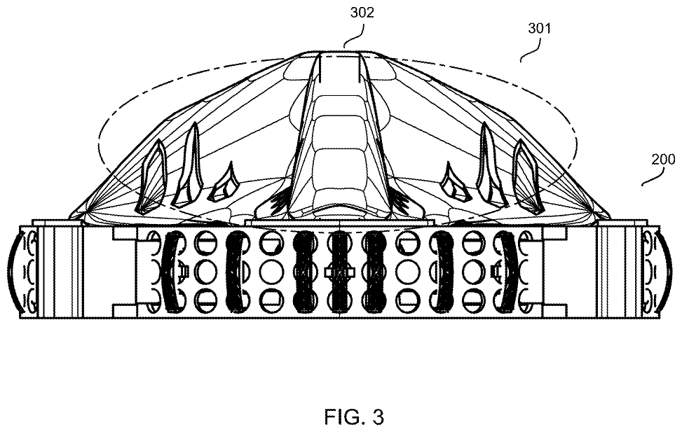

FIGS. 2 and 3 illustrate at least two different side section views of the SFZ wheel depicting the various zones for flexibility and rigidity, in accordance with the subject matter described herein, The SFZ wheel 200 comprises three or more types of zones, including a climbing member zone 201, a selective flex zone 202, and a support zone 203. Each of these zones are coupled to a central compression zone 205 which is located at the center of the SFZ wheel. In one or more embodiments, the SFZ wheel may include a side impact reduction zone 301 preferably bulging outwards sideways from the central compression zone 205 and support zones 203.

As depicted in FIG. 2, the SFZ wheel 200 comprises three climbing member zones 201. However, it may be apparent to one skilled in the art that there may be more or less than three climbing member zones 201 in the SFZ wheel 200. Each climbing member zone 201 comprises a climbing member 207. Each climbing member 207 extends substantially at 90 degrees (in the plane of the SFZ wheel 200) from the point at the outer periphery of the central compression zone 205, where it is coupled to the central compression zone 205. Further, each climbing member 207 in the climbing member zone 201 is coupled yet mechanically isolated to two SFZs 202, one at each of two sides of the climbing member 207.

In the example depicted in FIG. 2, each SFZ 202 is coupled to and is adjacent to a climbing member 207 at one side of the SFZ 202. Each SFZ 202's outer edge has two parts. For an SFZ wheel 200 not experiencing climbing load, while a first part of each SFZ 202's outer contact edge 204 substantially runs along the approximately circular perimeter of the SFZ wheel 200, the second part of each SFZ 202's outer edge is a portion that can be deflected inwards from the approximately circular perimeter of the SFZ wheel 200. The inward deflection of the SFZ 202's second part of outer contact edge 204 facilitates creation of a spacing between the climbing member 207 and the first part of the SFZ 202, thereby providing a space for the first part of the outer contact edge 204 to bend inwards towards the climbing member 201, during/after encountering an obstacle or climbing of stairs by the wheel. During/after obstacle encountering or climbing of stairs, the first part of the outer contact edge 204 (which runs along the perimeter of the SFZ wheel 200 in the stationary SFZ wheel 200), can be compressed inwards (towards the climbing member 201) from the approximately circular perimeter of the SFZ wheel 200. Such inward compression allows the climbing member 207 to grab a stair or obstacle during its movement. While each SFZ 202 is coupled to the climbing member zone 201 at one side, it is coupled to a support zone 203 on the other side. In other words, and as depicted, each SFZ 202 is sandwiched between a climbing member zone 201 and a support zone 203 of the SFZ wheel 200.

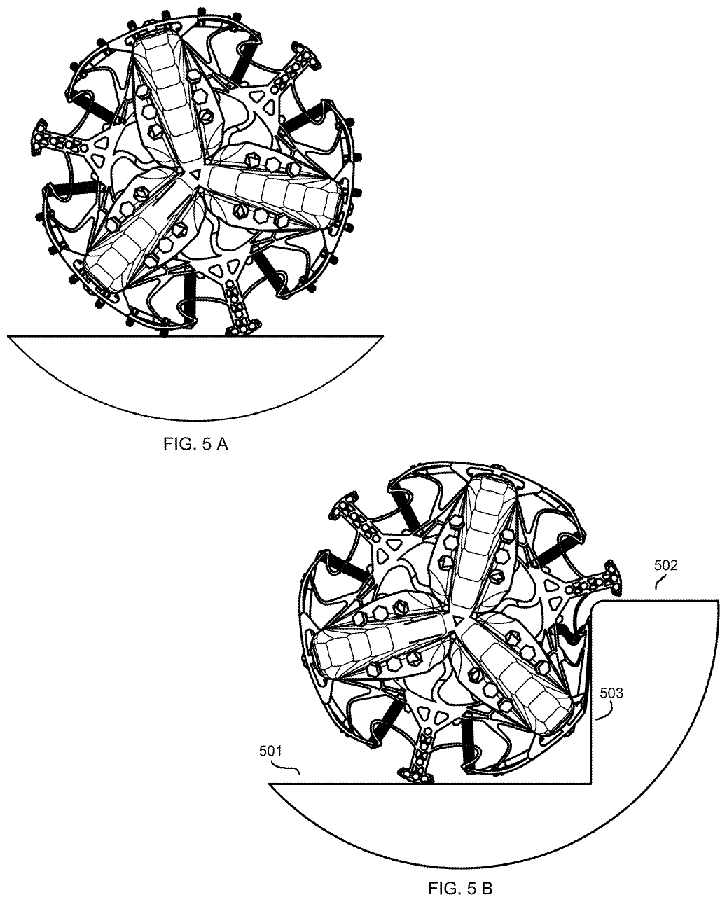

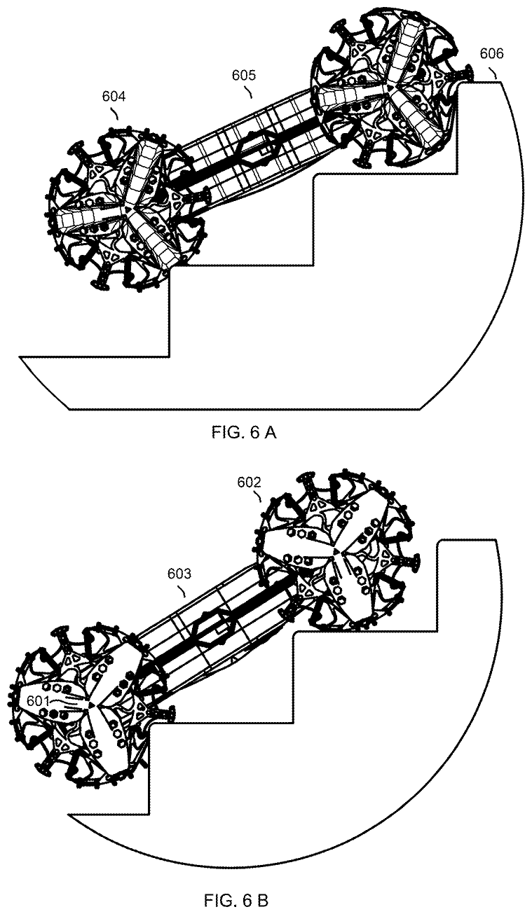

The SFZ 202 is the zone in the perimeter of the SFZ wheel 200, where the outer contact edges 204 connecting to the central compression zones 205 and the support zones 203 of the SFZ wheel 200 creates a support that may compress (as depicted in FIG. 5B) under climbing load to reveal the climbing member. The support in the SFZ 202 is facilitated based on its manufacturing material properties (e.g., an elastomer). The material and structure of the SFZ 202 supports driving over smooth surfaces, while compressing through buckling and elastically deforming when rough terrain causes climbing load. The climbing load is defined as the combination of one or more reaction forces acting inward to the SFZ wheel 200 induced by the following: a forward rolling force produced by the SFZ wheel 200 (as depicted in FIG. 5B), asecondary rear wheel 604 pushing into the obstacle 606, the downward load of gravity acting on the wheel center 601 as it lifts into free space (FIG. 6B). In one or more embodiments, the SFZ 202 may include, but is not limited to, a column 405 designed with a calibrated buckling load that collapses, a spring or equivalent insert and/or shape 406, a cantilever member 404 stemming from the support zone 203, integrated into the SFZ 202 with the specific compression and flex characteristics to support and compress under the climbing loads. As discussed above, the outer edge 204 of the SFZ 202 is mechanically isolated from the climbing member zone 201 near the climbing head (402) by a space/gap, so that when the SFZ 202 is compressed, it allows the climbing member to grab the stair or other rough terrain. The SFZ 202 is located symmetrically around the wheel in front of and behind the climbing member zones, offering the flexibility to operate in a forward and a reverse climbing motion.

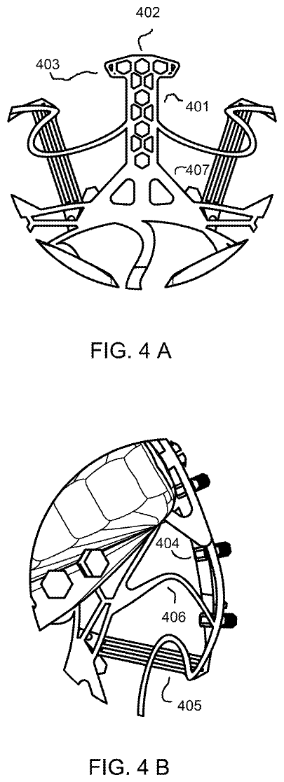

The climbing member zone 201 including the climbing member 207 is a rigidly designed section, based on the elastomer material properties. The climbing member 207 reaches the outer perimeter of the SFZ wheel 200 and has a hammer-shaped head 402, as depicted in FIG. 4. The outer edge of the climbing member 207 is rounded to follow the approximately circular perimeter of the SFZ wheel 200, and is mechanically isolated by a space from the selective flex zones 202 located on its either side. The face 403 of the climbing head 402 is configured to contact the top surface 502 of the object to be climbed, when the SFZ 202 is compressed due to the climbing loads, as depicted in FIG. 5B. The motion of the wheel is when the bottom surface 501 directly under the wheel provides a base for forward motion of the wheel, when an obstacle with a vertical face 503 is encountered, the wheel rotates in place with a forward rotating motion such that the SFZ 202 comes into contact with the corner where the vertical face of the obstacle and the top surface meet. For regular obstacles, such as stairs, the top surface 502 and vertical face 503 are defined as the two surfaces roughly perpendicular to each other with the stair edge being the zero coordinate or the reference point. Similarly, for non regular obstacles, the top surface will be wherever the climbing member can gain purchase. At this point, the SFZ 202 begins to compress due to the climbing load of the wheel rotating forward, pushing into the vertical face 503 of the obstacle which then reveals the climbing head 402. The climbing head 402's hammer shape displaces the climbing member face 403 from the climbing member arm 401 so that the force exerted by the SFZ wheel 200 at the face 403 when climbing (FIG. 5B) imparts a vertical force on the top surface 502 of the stair/obstacle. This prevents the climbing member arm 401 from pressing on the vertical face 503 of the stair and prevents imparting a backwards horizontal force off the stair. The climbing member 207 is designed with a slender outreaching main body, the climbing member arm 401, that is supported towards the base 407 through which the climbing member 207 is coupled to the central compression zone 205. This leaves room for the selective flex zone 202 to compress into the wheel and expose the maximum amount of the hammer shaped climbing head 402, and/or may expose the face 403 to the top surface of the obstacle. The structure and design of the climbing member 207 and its base 407 are supported and designed to have minimal deflection while lifting the mass (FIG. 6) of the mobility platform (603, 605), wherein its relative position on the perimeter of the wheel has a small change while climbing in relation to the strain deflection of the elastomer. The climbing member is designed to compress minimally while the mobility platform weight load is directly over the climbing member zone and not under climbing load.

A support zone 203 of the SFZ wheel 200 is located in between two selective flex zones 202 along the perimeter of the SFZ wheel 200, as depicted in FIG. 2. While FIG. 2 depicts only three support zones 203, it may be apparent to a person skilled in the art that there may be more or less than three support zones 203 based on the configuration of the SFZ wheel 200. The outer edge of the support zone 203 follows the outer perimeter of the SFZ wheel 200 to create a smooth driving roll through the support zone 203. The support zone 203 is designed/configured to have an elastomer structure 203 that will compress under impact loads, but not under driving and climbing loads. The thickness and shape of the elastomer are designed to have minimal deflection under driving loads and large deflection under loads greater than climbing loads. Driving loads are defined as the sum of forces on the wheel including the weight of the mobility platform acting in the direction of gravity on the center of the wheel, and the force of friction from the ground resisting motion of the wheel where it is contacting the ground creating a torque load at the center of the wheel that may be useful to initiate forward motion. The shape of the support zone 203 is wide as it reaches the base 401 of the climbing member zone 201 and tapers as it reaches out towards the outer perimeter of the SFZ wheel 200. At the outer radius of the wheel, starting at the support zone 203 an arc-shaped cantilever member 404 stretches to each SFZ 202 on either side of the support zone 203. The arc shaped portion 404 of the support zone 203 is supported at the middle and creates a cantilever member 404 on either side ending at the SFZ 202.

The central compression zone 205 may absorb large impacts and/or may act as a shock absorber for the connected apparatus. The central compression zone 205 comprises a plurality of radial members. The shape and size of the radial members in the central compression zone 205 are designed to compress toward the center of the SFZ wheel 200 when an impact force greater than climbing and driving loads acts inwards toward the center of the wheel. The thickness and shape of the elastomer are designed to have minimal deflection under driving loads and large deflection under loads greater than climbing loads. The center of the central compression zone is attached to the driving axle of the mobility platform. The radial members are rigid enough that forces acting at the outer perimeter of the SFZ wheel 200 parallel to the driving axis at the center of the SFZ wheel 200 do not cause the wheel to fold over due to the flexibility of the elastomer. The central compression zone 205 has radially extending members that maintain torsional rigidity due to thickness and shape when torque from the central hub is acting on the climbing member 207 at the outer perimeter/periphery of the SFZ wheel 200.

The side impact reduction zone SIRZ 301 dissipates shock loads enacted along the driving axis of the SFZ wheel 200. The elastomer shapes of the SIRZ 301 are designed to compress under impact loads, the distance of the compression lessens the peak impact forces on the main body connected to the SFZ wheel 200. The SIRZ is constructed of one or more convex surfaces that reach from the maximal height at the center of the wheel to the perimeter of the wheel. In one or more embodiments, the SIRZ 301 may include the rounded profile it creates perpendicular to the main diameter of the wheel. The rounded profile and the maximal height of the profile arc 302. creates an unstable system so that the connected mobility application (603, 605) rolls back to the main driving surface of the wheel. Wherein the maximal height to the perimeter of the wheel creates a surface that when rested on the center of mass of the mobility platform falls outside of the created surface base.

An implementation of typical use is robotic applications. Often in a hazardous area for the user to enter, the application may be reliable at self-righting 301 and/or getting over obstacles including steps without further assistance. There may be a risk of the robot falling, perhaps for example due to the hazards of the area and/or to get to a certain hazardous area. These devices are often deployed through a drop or throw and the ability to self right while in motion may be useful.

Replaceable tread inserts are located around the perimeter of the wheel. The treads may be a wear item that may be replaced over time and have material properties that have a greater coefficient of friction on surfaces than the elastomer. On the face of the climbing member 403, the surface may be coated and/or may have a replaceable insert that creates a higher coefficient of friction with surfaces than the elastomer.

1. A wheel apparatus having an axis of rotation, comprising:
one or more rigid climbing members that extend to an outer perimeter of the wheel apparatus, the one or more rigid climbing member being configured to maintain shape and relative position over all surfaces the wheel apparatus encounters;
one or more selective flex zones located adjacent to the rigid climbing members, respectively, the one or more selective flex zones being configured to compress inwardly toward the axis of rotation when the wheel apparatus encounters an obstacle in a path of the wheel apparatus; and
one or more support zones located adjacent to the one or more selective flex zones, respectively, the one or more support zones being configured to provide support for smooth rotary motion of the wheel apparatus about the axis of rotation when not traversing obstacles.

2. The wheel apparatus of claim 1, wherein the one or more selective flex zones are configured to support a weight of a mobility platform and maintain roundness over surfaces without obstacles, and wherein compression of the one or more selective flex zones when subjected to a load or an obstacle exposes at least one of the one or more rigid climbing members of the wheel apparatus.

3. The wheel apparatus of claim 2, wherein at least a portion of the one or more selective flex zones, when subjected to the load or the obstacle is configured to deflect inwards from the outer perimeter of the wheel apparatus.

4. The wheel apparatus of claim 1, wherein the one or more selective flex zones is a plurality of selective flex zones, wherein each rigid climbing member is adjacent to two of the plurality of selective flex zones, thereby allowing the rigid climbing; member to be exposed when an obstacle is encountered in either direction of rotation.

5. The wheel apparatus of claim 4, wherein the rigid climbing member is mechanically isolated from each of the two adjacent selective flex zones at the outer perimeter of the wheel apparatus.

6. The wheel apparatus of claim 1, further comprising a central portion that includes a compression zone configured to absorb and dissipate loads applied along the outer perimeter.

7. The wheel apparatus of claim 1, wherein a side of the wheel apparatus further comprises one or more side impact reduction zones constructed of one or more convex surfaces.

8. The wheel apparatus of claim 1, further comprising of at least one replaceable tread inserts

9. The wheel apparatus of claim 1, further comprising of at least one replaceable traction pads attached to the climbing face of the one or more rigid climbing members.

10. The wheel apparatus of claim 1, wherein an entirety of the wheel apparatus is formed from a single elastomer material.

11. A mobility of platform further comprising a wheel apparatus according to claim 1.
